(19) United States
(12) Patent Application Publication
(10) Pub. No.: US 2012/0251861 A1
(43) Pub. Date: Oct. 4, 2012

(54) SHOCK PROOF STRUCTURE OF BATTERY PACK FOR RECEIVING BATTERY CELL

(75) Inventors: Chia-Sheng Liang, Taipei Hsien (TW); Chu-Hsiang Tseng, Taipei Hsien (TW)

(73) Assignee: DE POAN PNEUMATIC CORP.

(21) Appl. No.: 13/076,719

(22) Filed: Mar. 31, 2011

(51) Int. Cl. H01M 2/10; B25F 5/02

(52) U.S. Cl. 429/98; 429/100

(57) ABSTRACT

A shock proof structure of a battery pack for receiving a battery cell is formed in an electrical tool. The battery pack includes a base having a space for receiving the battery cell and a lid for opening or closing the space. The space has a plurality of first buckling portions separated by a gap disposed at a bottom side thereof. A plurality of second buckling portions with shock absorbance is formed at an inner sidewall of the lid. The plate sets include two plates separated by a gap are symmetrically positioned. The plates of each plate set have a second buckling portion with a stretching gap formed in between. The second buckling portion is positioned at the opposite end of the first buckling portion to provide the battery cell to be steadily buckled between the first and the second buckling portions.

### BACKGROUND

1. Technical Field

The present invention relates to a shock proof structure of a battery pack for receiving a battery cell. More particularly, the present invention relates to a space formed in a base of a battery pack for receiving a battery cell; especially to a lid for opening or closing the space, as well as shock proof plates on the lid.

2. Related Art

An electrical tool, for example, electrical screw gun, electrical nail gun, electrical screwdriver, electrical driller, electrical wrench, etc, can be driven by a portable battery pack allowing users to use indoor/outdoor anywhere away from the power socket. Conventional battery pack is disposed at a distal end of an electrical tool including a space formed at a side of the base thereof to receive a battery cell, and comprises a lid that opens or closes the space. The battery cell is generally formed in a cylinder shape. Serious shock or collision may easily occur to the battery cell when the electrical tool is under impact or dropped on the ground and cause damage to the battery cell. U.S. Pat. No. 5,792,573 has proposed a plurality of ribs in the space to suppress and protect the battery cell from the impact. However, the result is not ideal.

Another patent, US patent No.20100156350, disclosed a structure for a battery pack of an electrical tool including two inner plates comprising a plurality of arch faces in the space for holding the two sides of the battery cell for positioning.

The latter prior art has a complex structure of an inner plates that increases the manufacturing cost. Besides, even though the resilient material may be used to form the inner plate to increase the shock absorbing ability for the arch faces. However, the stretching limitation of the inner plates limits the shock absorbing ability. Therefore, there are still some improvement can be done in this respect.

### BRIEF SUMMARY

The present invention provides a shock proof structure of a battery pack for receiving a batter cell, which comprises shock absorbance to firmly hold the battery cell within the battery pack, as well as provides a simplified structure of the shock proof structure of the battery pack and upgrades the stability of holding the battery cell within the battery pack.

The shock proof structure of a battery pack for receiving a battery cell in the present invention includes a base comprising a space for receiving the battery cell at a side thereof. A lid is connected to the base for closing or opening the space. A plurality of first buckling portions are formed at a bottom of the space, wherein the buckling portions are separated from each other by a distance.

A plate set, including a plurality of plates separated from each other by a gap, with shock absorbance is positioned at an inner sidewall of the lid. The plate set comprises two plates with a gap there-between is symmetrically positioned. The plate has an arm positioned upright in the lid. A bent portion is formed at a distal end of the arm. The plate has a supporting arm formed extending from the bent portion declining towards the inner sidewall of the lid. The support arms of every plate set are symmetrically positioned with the adjacent support to form the second buckling portions with the stretchable gap. The second buckling portion is positioned at a corresponding end to the first buckling portion. Thus, the battery cell can be buckled to be positioned between the first and the second buckling portions.

According to the above depiction, the support arm of the plate has elasticity provided by the arm and the bent portion, and the stretchable gap helps to increase the stretching ability. Thus the ability for shock proof and holding effect of the battery cells between the first and the second buckling portions can be increased, and also the shock proof structure of battery pack may be simplified and upgrade the stability of holding the battery cell within the battery pack.

The embodiment of the present invention further comprises a plurality of plate sets positioned parallel to each other, so are the plates parallel to one another; and a supporting arm is formed in an arch shape, wherein an angle of the supporting arm with respect to the arm is acute.

A plurality of through grooves are formed and separated from each other by a distance, on the lid on the side of the arm to correspond with the supporting arm. A buffering space is formed between the supporting arm, and the bent portion and the arm is connected to the stretching gap and through groove.

The lid is covered by a soft pad made of a rubber material for absorbing the shock from external impact.

The pad fills in the buffering space through the through groove to increase the elasticity of the support arm and the arm.

A plurality of trenches are formed on the outer portion of the pad for providing anti slippery feature; and the trenches are separated from each other by gap.

The distance between the first buckling portion and the second buckling portion is slightly smaller than a dimension of the battery cell.

The base can be inlayed in the distal end of the handle of an electrical tool.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an electrical tool according to an embodiment of the present invention;

FIG. 2 is an exploded view of a battery pack in FIG. 1 according to an embodiment of the present invention;

FIG. 3 is an enlarged exploded view of an inner sidewall of a lid in FIG. 2 according to an embodiment of the present invention.

FIG. 4 is an enlarged exploded view of an inner sidewall of a pad in FIG. 2 according to an embodiment of the present invention.

FIG. 5 is a prospective view of FIG. 1 according to an embodiment of the present invention.

FIG. 6 is a local enlarged sectional view taken from FIG. 5 according to an embodiment of the present invention;

FIG. 7 is an enlarged sectional view taken from FIG. 6 according to an embodiment of the present invention;

FIG. 8 is an operational aspect of FIG. 7 according to an embodiment of the present invention; and

FIG. 9 is a sectional view according to a second embodiment of the present invention.

### DETAILED DESCRIPTION

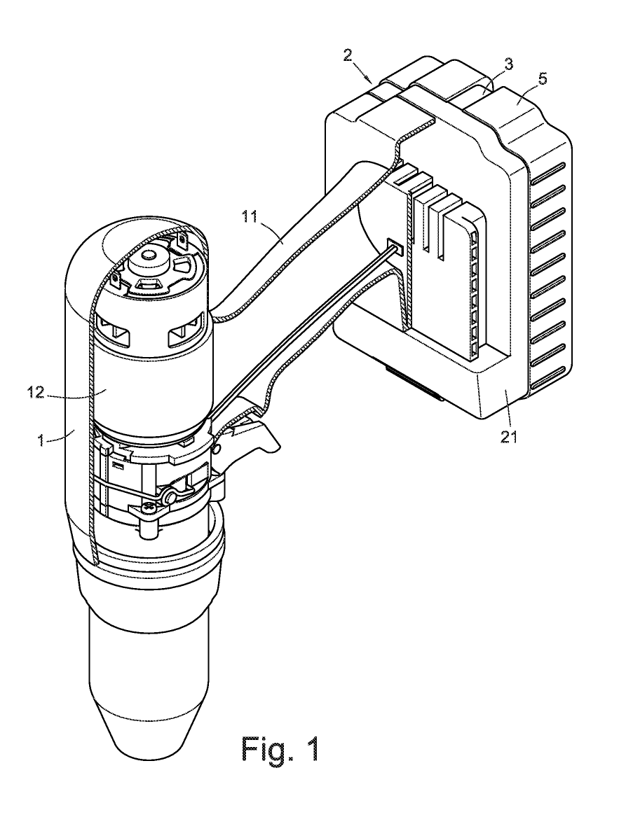

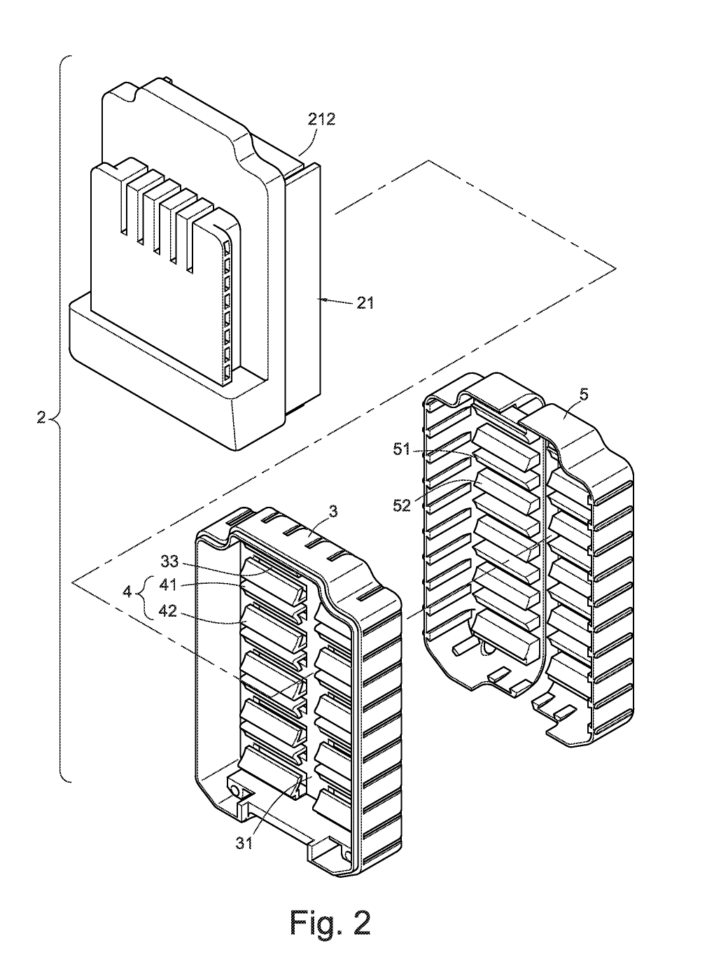

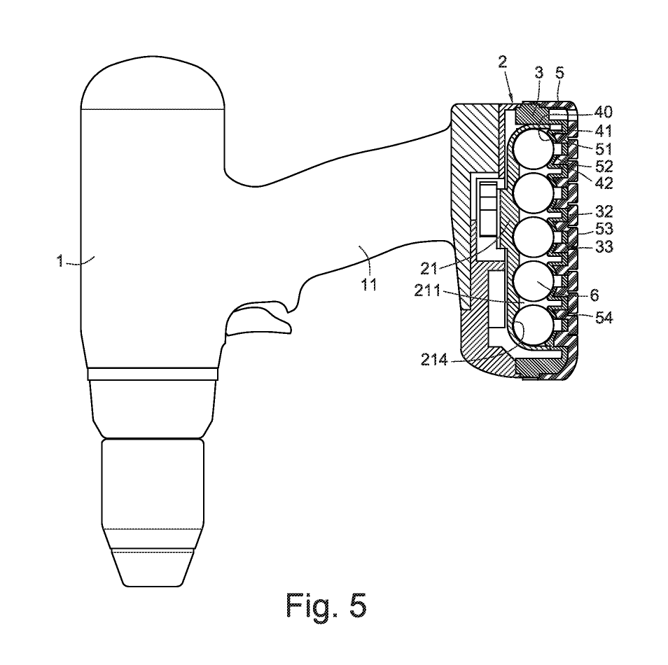

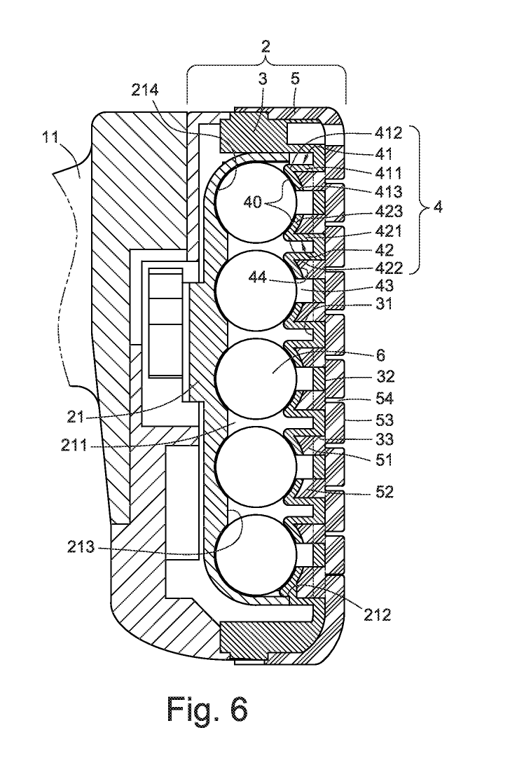

Referring to FIGS. 1 and 5, a shock proof structure of a battery pack 2 for receiving a battery cell is disclosed. The battery pack 2 comprises a base 21 inlayed at a distal end of a handle 11 of an electrical tool 1. The electrical tool 1 can be an electrical screw gun, an electrical staple gun, an electrical screw driver, an electrical driller, an electrical impact wrench and so on. Taking the electrical screw gun as an example in the embodiment of the present invention, the base 21 comprises a space 211 for receiving the battery cell (referring to FIG. 6) and connected with a lid 3 for opening or closing the space 211. A plurality of buckling portions 214 with gap between one another are formed at the bottom 213 of the space 211 (referring to FIG. 8). The first buckling portion 214 in the embodiment can be an arch shape. The power supplied by the battery cell 2 can be transmitted through the handle 11 to the electrical tool for driving the motor 12.

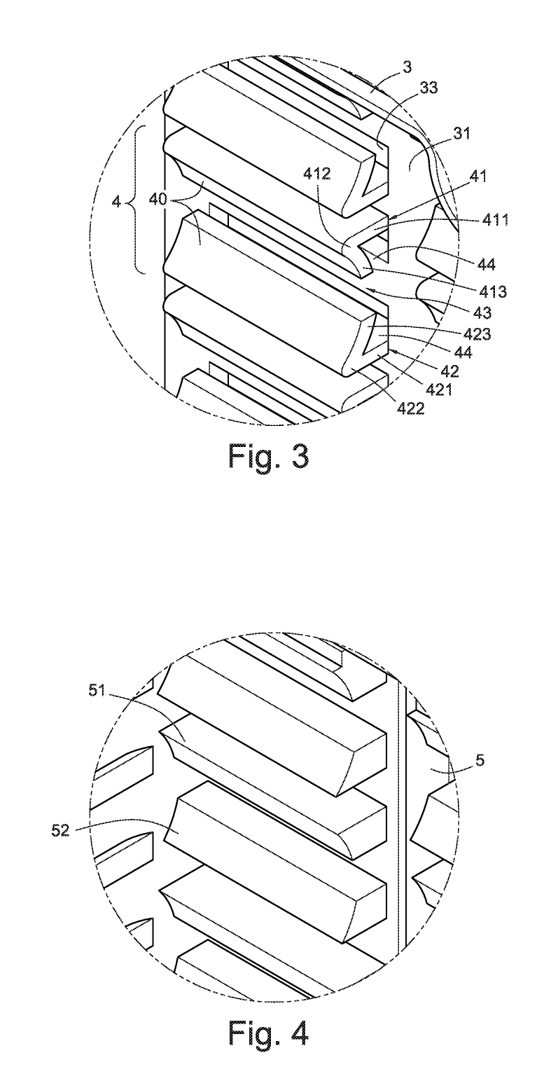

Accordingly, a plurality of plate sets 4 with shock absorbance, separated from each other by a gap, are disposed on the inner sidewall 31 of the lid 3 (as shown in FIGS. 3 and 6). The plate sets 4 are positioned in an array and parallel to each other. The plate sets 4 comprise first plates 41 and second plates 42 with gaps there-between and positioned symmetrically. The first plates 41 and the second plates 42 are positioned parallel to each other. The lid 3 and the first and second plates 41, 42 can be made of a plastic material. The first plate 41 comprises a first arm 411 positioned upright at an inner sidewall 31 of the lid 3 (referring to FIG. 8). The first arm 411 comprises a first bent portion 412 formed at a top end; and the first plate 41 comprises a first supporting arm 413 extending from the first bent portion 412 declining towards the inner sidewall 31 of the lid 3. The second plate 42 comprises a second arm 422 positioned upright on the inner sidewall 31 of the lid 3. The second arm 421 comprises a second bent portion 422 at the top end thereof; and the second plate 42 comprises a second supporting arm 423 extending from the second bent portion 422 declining towards the inner sidewall 31 of the lid 3.

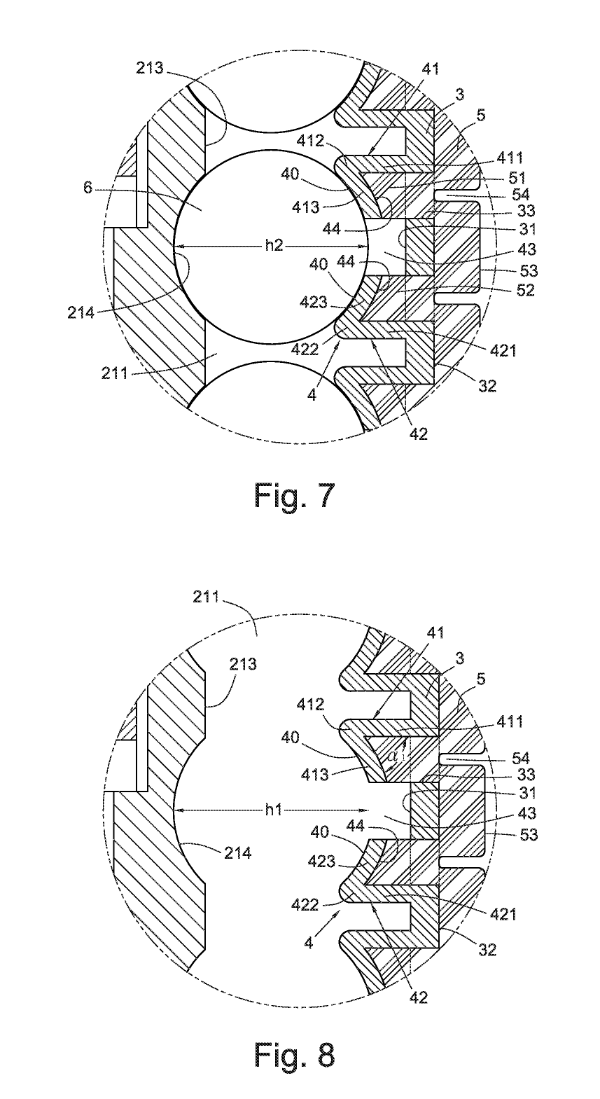

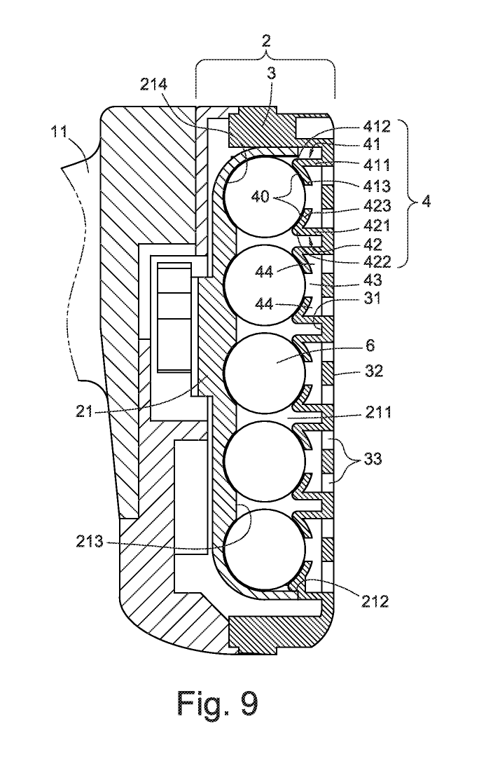

The first and second arms 413, 423 of each plate sets 4 are adjacent to each other symmetrically to form a second buckling portion 40 with a stretching gap 43 (as shown in FIGS. 3 and 6). The second buckling portion 40 is positioned at an end opposite to the first buckling portion 214. The supporting arms 413, 423 can be formed in an indented arch shape. The angle a formed between the supporting arms 413, 423 and the arms 411, 421 is acute (referring to FIG. 8). A buffering space 44 is formed between the supporting arms 413, 423, bent portions 412, 422 and the arms 411, 421 (referring to FIG. 9). The distance h1 between the second buckling portion 40 and the first buckling portion 214 is slightly smaller than the dimension h2 of the battery cell 6 (as shown in FIG. 7). The battery cell 6 in the present embodiment can be cylindrical and is in contact with the first buckling portion 214 and the second buckling portion 40 with the full face or a cutting edge in order to buckle and position between the first and second buckling portions 214, 40.

The lid has a plurality of through grooves 33 separated from each other by a gap and formed between the inner sidewall 31 and outer sidewall 32 (as shown in FIGS. 3 and 6). The through grooves 33 are respectively formed on the side of the arms 411, 421 corresponding to the supporting arms 413, 423. The buffering space 44 is formed between the stretching gap 43 and the through groove 33 (referring to FIG. 7). The through grooves 33 are formed parallel to each other. The outer sidewall 32 of the lid 3 is covered by soft pad 5 made of a rubber material. The battery pack 2 can have the outer shock absorbed by the pad 5. The pad 5 fills into the buffering space 44 through the through groove 33. A plurality of block sets are formed at an inner sidewall of the pad 5 and the block sets are separated from each other by an equal distance. Each block set comprises a first block 51 and a second block 52 separated from each other by an equal distance (also referring to FIG. 4). The first block 51 fills between the first supporting arm 413, the first bent portion 412, the first arm 411 and the through groove 33. The second block 52 fills between the second supporting arm 423, the second bent portion 422, the second arm 421 and the through groove 33. The battery pack 2 can absorb the shock through the first and second blocks 51, 52, and this structure would as well increase the elasticity of the supporting arms 413, 423 and the arms 411, 421. The pad 5 and the blocks 51, 52 can be integrally formed as one piece through the through groove 33 to increase the convenience. The outer sidewall 53 of the pad 5 comprises a plurality of trenches separated from each other by an equal distance, and for providing an anti slippery effect. The trenches 54 are respectively formed at a side opposite to the first and second blocks 51, 52. The pad 5 has anti slippery features due to the trenches 54 formed there-on.

According to the above depiction, the elements assembled in the embodiment of the present invention indicates, when the battery cell 6 is placed in the space 211 (referring to FIGS. 5 and 7) and positioned between the first and the second buckling portions 214, 40, because the distance h1 between the first buckling portion 214 and the second buckling portion 40 is slightly smaller than the dimension h2 of the battery 6 (referring to FIG. 8); therefore, the first and second supporting arms 413, 423 are respectively pressed by the battery cell 6 to cause the elastic distortion through the stretching gap 43 towards the inner sidewall 31 of the lid 3, thus to buckle the battery cell 6 between the first and second buckling portions 214, 40. When the electrical tool 1 is subjected to an impact, the supporting arms 413, 423, the bent portions 412, 422, the arms 411, 421 and the blocks 41, 42 absorb the shock caused by the impact on the electrical tool 1 to prevent the damage to the battery cell 6.

Accordingly, the supporting arms 413, 423 of the plates 41, 42 have elasticity provided by the arms 411, 421 and the bent portions 412, 422, and the stretching gap 43 upgrades the stretching effect. Thus, the shock absorbance and anti slippery effect of the first and second buckling portions 214, 40 buckling the battery cell 6 can be increased, and the shock proof structure of the battery pack can be simplified, and also upgrade the stability of positioning the battery cell 6 within the base of the electrical tool.

Referring to FIG. 9, a sectional view according to the second embodiment of the present invention is disclosed, wherein the difference between the two embodiments is that the second embodiment does not comprise the pad coating the outer sidewall 32 of the lid 3 and the block of the pad, and the remaining elements are the same as the first embodiment.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A shock proof structure of a battery pack for receiving a battery cell; the battery pack comprising:
a base, having a space for receiving the battery cell; wherein a plurality of first buckling portions separated from each other by a gap are disposed at bottom of the gap; and
a lid joined with the base, comprising a plurality of plate sets for absorbing shock and positioned on the inner sidewall of the lid; wherein each of the plate sets comprise two plates with gap there-between and symmetrically positioned; the plate comprise an arm positioned upright at the inner sidewall of the lid; the arm comprises a bent portion formed at a top thereof; the plate comprises a supporting arm extending from the bent portion towards side inner sidewall of the lid; each plate set comprises a second buckling portion with a stretching gap symmetrically formed between the supporting arms; and the second buckling portion is disposed at an end opposite to the first buckling portion; and the battery cell is buckled between the first buckling portion and the second buckling portion.

2. The shock proof structure of a battery pack for receiving a battery cell according to claim 1, wherein the plate sets are parallel to each other.

3. The shock proof structure of a battery pack for receiving a battery cell according to claim 1, wherein the supporting arm is formed in an indented arch shape.

4. The shock proof structure of a battery pack for receiving a battery cell according to claim 1, wherein the supporting arm and the arm form an acute angle.

5. The shock proof structure of a battery pack for receiving a battery cell according to claim 1, wherein the lid comprises a plurality of through grooves separated from each other by a distance, which is positioned on a side of the arm corresponding to the supporting arm; and a buffering space is formed between the supporting arm, the bent portion and the arm.

6. The shock proof structure of a battery pack for receiving a battery cell according to claim 5, wherein the lid comprises a soft pad made of a rubber material covering an outer portion thereof.

7. The shock proof structure of a battery pack for receiving a battery cell according to claim 6, wherein the pad is filled into the buffering space through the through groove.

8. The shock proof structure of a battery pack for receiving a battery cell according to claim 6, wherein the pad comprises a plurality of trenches formed on an outer sidewall thereof for providing anti-slippery effect.

9. The shock proof structure of a battery pack for receiving a battery cell according to claim 1, wherein a distance between side second buckling portion and the first buckling portion is smaller than a dimension of the battery cell.

10. The shock proof structure of a battery pack for receiving a battery cell according to claim 1, wherein the base is inlayed at a distal end of a handle of an electrical tool.
